(19) United States
(12) Patent Application Publication
(10) Pub. No.: US 2026/0029957 A1
(43) Pub. Date: Jan. 29, 2026

(54) Scalable Techniques to Process Separate Queues of Storage Access Commands from a Host System to a Memory Sub-System

(71) Applicant: Micron Technology, Inc., Boise, ID (US)

(72) Inventor: Luca Bert, Bologna (BO) (IT)

(21) Appl. No.: 18/785,991

(22) Filed: Jul. 26, 2024

(51) Int. Cl. G06F 3/06

(52) U.S. Cl. CPC G06F 3/0659; G06F 3/0604; G06F 3/0679

(57) ABSTRACT

A memory sub-system configured via instructions to: perform an analysis of queue statuses of a plurality of submission queues without accessing the submission queues; determine priorities of the submission queues based on a result of the analysis; select one or more submission queues based the priorities; retrieve, from the one or more submission queues, a subset of storage access commands in the plurality of submission queues; and execute the subset of storage access commands. After the retrieval and/or identification of the subset of storage access commands, the memory sub-system can further perform analysis of current queue statuses to identify a next subset of storage access commands for execution.

### TECHNICAL FIELD

At least some embodiments disclosed herein relate to memory systems in general, and more particularly, but not limited to execution of commands provided by host systems to memory sub-systems via submission queues.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows an in-memory status array configured for a host system to identify statues of submission queues to a memory sub-system according to one embodiment.

FIG. 3 to FIG. 6 show different configurations of in-memory status arrays and queue pairs configured according to some embodiments.

FIG. 7 illustrates a technique of using command TagID to identify queue statuses according to one embodiment.

FIG. 8 shows a memory sub-system configured to determine the amounts of commands in submission queues according to one embodiment.

FIG. 9 illustrates a doorbell register according to one embodiment.

FIG. 10 and FIG. 11 show information tracked by a queue manager in a memory sub-system to schedule command retrieval and execution according to some embodiments.

FIG. 12 to FIG. 15 show methods to manage queues of commands for execution in a memory sub-system according to one embodiment.

FIG. 16 is a block diagram of an example computer system in which embodiments of the present disclosure can operate.

### DETAILED DESCRIPTION

At least some aspects of the present disclosure are directed to techniques to manage commands submitted for execution in a memory sub-system. For example, the memory sub-system can receive commands from a host system for execution using submission queues configured in a memory accessible to both the memory sub-system and the host system. An in-memory array can be configured to indicate the command submission statuses of the queues such that the memory sub-system can read the in-memory array to decide how to the prioritize the queues for processing, without having to read the submission queues in order to decide how to schedule the commands in the submission queues for execution.

Consider, for example, a scenario of a memory sub-system (e.g., solid-state drive (SSD)) used in artificial intelligence (AI) inference computations. A trained artificial neural network (ANN) model can be used to make inference/predictions. Inference/prediction computations can have many tasks running in parallel on different graphical processing unit (GPU) cores.

For example, there can be over a hundred GPUs in a cluster, where each GPU can have hundreds of cores. Potentially, there can be over 10,000 or so inference processes running in parallel, each running in a separate GPU core to access a different part of the memory sub-system (e.g., solid-state drive (SSD)) storing the AI/ANN model. Each part being accessed can be small (e.g., less than the typical 4 KB logical block addressing (LBA) size of an SSD). Thus, the memory sub-system can be configured to support a large number of parallel commands coming from the inference processes running in the GPU cores.

The GPU cores can be configured to use a standardized protocol (e.g., non-volatile memory express (NVMe)) to access the memory sub-system (e.g., solid-state drive (SSD)). The GPU cores can provide their storage access commands (e.g., read commands, write commands) in a large number of submission queues for retrieval by the memory sub-system. Some GPU cores may produce more input/output requests (e.g., read commands, write commands) than others, which can lead to an unbalanced distribution of commands across the large number of submission queues. Some submission queues can have lots of commands to be processed by the memory sub-system, while other submission queues have very few commands to be processed by the memory sub-system.

At least some aspects of the present disclosure address the above and other deficiencies and challenges by configuring an array in a memory that is accessible to both the memory sub-system and the host system to indicate the statuses of submission queues. Thus, the memory sub-system can read the array to determine the distribution of commands across the submission queues and determine an effective way, strategy, and/or priority to execute the commands, instead of having to read the submission queues to decide a schedule for the retrieval of commands from the submission queues for execution.

For example, a submission/completion queue pair (QP) can be set up according to an NVMe protocol between the memory sub-system and each respective GPU core so that the QP is dedicated to deliver storage access commands from the respective GPU core and to deliver completion messages to the GPU core.

However, a conventional solid-state drive is configured to implement QP support using an application specific integrated circuit (ASIC). Such a hardware-based QP solution can support up to 2048 QPs, which can be sufficient for most non-AI applications but insufficient for some AI applications. A hardware-based QP solution moving beyond the limit of 2048 QPs can break backward compatibility. Further, most non-AI applications use kernel-based drivers that rely for completion on the standard MSIX protocol which, in turn, is limited to 2048 vectors. Moving beyond the limit can break kernel compatibility.

To address the limit of 2048 QPs, a memory manager in the host system can be used to intercept the calls from GPU cores and merge calls from some GPU cores together into one submission queue. For example, if an 8:1 merging is in place, 2048 QPs can service 16K GPU cores. However, the merge operations can be a drag on performance, because merging calls from GPU cores (and delivering completion messages) can be a complex, synchronous operation that require the memory manager to lock a submission queue, insert entries/commands into the queue, unlock the queue, and perform similar operations for distributing the completion messages from the completion queue. The operations can cumulatively consume a very a large set of resources.

The present disclosure provides solutions to address the challenges in a scalable way. The solutions can be used to implement an efficient command delivery mechanism that can scale to any number of submission queues (e.g., from less than 2048 QPs to over 100,000 QPs). The solutions loosely follow the NVMe model for compatibility, and allow a memory sub-system (e.g., a solid-state drive (SSD)) to know how many commands are pending in any submission queue without reading the submission queue. Thus, the memory sub-system can make a more considerate decision about in which order the submission queues should be served.

The submission/completion queue pairs (QPs) involved in the solutions can be configured in a memory of the host system or a memory sub-system (e.g., solid-state drive (SSD)). Using the memory of the host system to implement QPs can be more scalable, flexible, and/or efficient in general.

One of the solutions provides an in-memory array that lists the statuses of all submission queues in the QPs.

For example, the array can have the same number of entries or slots as the number of QPs being used for communications between the host system and the memory sub-system. Each entry can be configured as an integer representative of the last command entered in a respective submission queue. The memory sub-system can be configured to monitor the array for the statuses of submission queues.

In a conventional approach, when an NVMe driver wants to submit one or more commands for execution by a solid-state drive (SSD), the NVMe driver can fill the commands in slots of a predetermined size in the submission queue, and then write to a specific PCIe address in the SSD to ring the doorbell, which tells the SSD that one or more commands is available in submission queues. Such an approach can be advantageous when the SSD is typically not very active; and the number of submission queues are small.

In an AI application, such notifications can be unnecessary. Commands can be almost always available in some of the large number of QPs. Thus, it can be advantageous to replace the doorbell mechanism of writing to a specific PCIe address in the SSD with the SSD checking the in-memory array for queue statuses provided by the host system.

When an NVMe driver writes to a specific PCIe address in an SSD to ring the doorbell according to a conventional approach, the SSD knows that there is one or more commands in the submission queues. The SSD is to search the submission queues to determine which of the submission queue(s) has/have the command(s) for which the NVMe driver rings the doorbell.

In contrast, the in-memory status array allows a memory sub-system to determine, without reading the submission queues, which submission queues have new commands added since last check of the in-memory status array.

For example, each respective GPU core can run its own local instantiation of a simplified NVMe driver that acts only on the input/output requests issued by the respective GPU core. The driver can be configured to track a TagID of each command added to a submission queue. The TagID can be a sequential rolling number associated with each command, where the TagID of a current command being added to a submission queue is one increment larger than the TagID of the immediate prior command added to the submission queue. When the TagID reaches a maximum (e.g., 64K), it can roll over to zero. For example, the TagID of a first command being added to a submission queue can be 0x0; the second command being added to the same submission queue can be 0x1; and so on, when the TagID reaches the maximum of 0xFFFF, it can roll back to 0x0 for the next command being added to the submission queue.

The driver running in the GPU core can be configured to write the TagID of the last command added to the submission queue into a corresponding element/slot in the in-memory status array, where the element/sot is pre-associated with the submission queue. For example, when the submission queue is the n'th submission queue configured for the memory sub-system, the driver can write the TagID of the last command added to the submission queue into the n'th element/slot of the in-memory status array.

Based on checking the TagID recorded in the in-memory status array for a submission queue, the memory sub-system can determine how many commands have been added to the submission queue since the last check.

For example, if the memory sub-system decides to check the status of commands in the n'th submission queue, the memory sub-system can retrieve the TagID from the n'th element of the in-memory status array. For example, during an initial check, the TagID found in the n'th element is p; and thus, the memory sub-system can determine that there are p+1 commands in the submission queue, since the first command added to the queue has a TagID of zero. Subsequently, when the TagID found in the n'th element becomes q, the memory sub-system can determine that the number of new commands added between the checks is q-p if q is no smaller than p, or 0xFFFF+q−p+1 if q>p.

Thus, the in-memory status array provides an efficient way for the memory sub-system to determine both whether there are commands in a submission queue and how many of commands are pending in the submission queue. Based on the TagIDs provided in the status array, the memory sub-system can decide which submission queue is to be given precedence and/or the processing order of the submission queues to keep the system balanced in workloads.

When such a solution is used, the memory sub-system can be configured to check the in-memory status array to select one or more submission queues for processing. Through comparing the TagIDs currently in the status array and their previous values, the memory sub-system can determine how many new commands have been posted for each of the submission queues being checked. Based on the results of determining the quantities of new commands having been added to the submission queues, the memory sub-system can decide which submission queue(s) to serve first and for how many commands. For example, the memory sub-system can use a direct memory access (DMA) engine to pick up commands from the selected submission queues according to the selected number of commands. After the processing of the commands, the memory sub-system can repeat the process of reading the in-memory status array to select next submission queues for command retrieval and execution. The processing loop can be implemented via execution of instructions (e.g., software/firmware) in the memory sub-system to avoid the limit of 2048 QPs. Thus, the memory sub-system can handle a wide range of QPs (e.g., less than 2048 QPs for non-AI applications, and more than 100,000 QPs for AI applications).

Upon completion of execution of a command retrieved from a submission queue, the memory sub-system can add a completion message to a corresponding completion queue. The driver running in the GPU core can retrieve the completion message from its dedicated QP.

When the number of GPU cores increases to more than 2048 QPs, the system can accommodate the use of one QP per GPU core without the need for a memory manager to lock queues, to merge commands into submission queues, and to dispatch completion messages.

Aside from a few changes discussed above, such a solution is substantially compatible with the existing NVMe driver stack to preserve the general storage stack investments. The solution can work with most existing host side storage infrastructure (e.g., io_uring) without significant modifications.

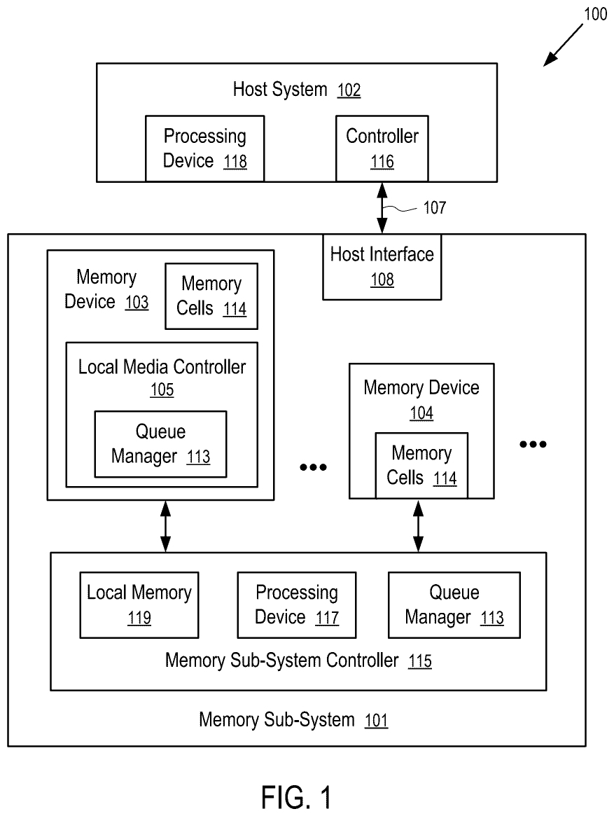

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a queue manager 113 configured to perform operations related to determination of statuses of submission queues of commands for execution in the memory sub-system 101. In some embodiments, the controller 115 in the memory sub-system 101 includes at least a portion of the queue manager 113. In other embodiments, or in combination, the controller 116 and/or the processing device 118 in the host system 102 includes at least a portion of the queue manager 113. For example, the controller 115, the controller 116, and/or the processing device 118 can include logic circuitry implementing the queue manager 113. For example, the controller 115, or the processing device 118 (processor) of the host system 102, can be configured to execute instructions stored in memory for performing the operations of the queue manager 113 described herein. In some embodiments, the queue manager 113 is implemented in an integrated circuit chip disposed in the memory sub-system 101. In other embodiments, the queue manager 113 can be part of firmware of the memory sub-system 101, an operating system of the host system 102, a device driver, or an application, or any combination therein.

For example, the queue manager 113 implemented in the controller 115 and/or 105 of the memory sub-system 101 can be configured to retrieve information provided by the host system 102 in an in-memory status array to determine the statuses of commands in submission queues, to determine which submission queues to server, etc., as further discussed below.

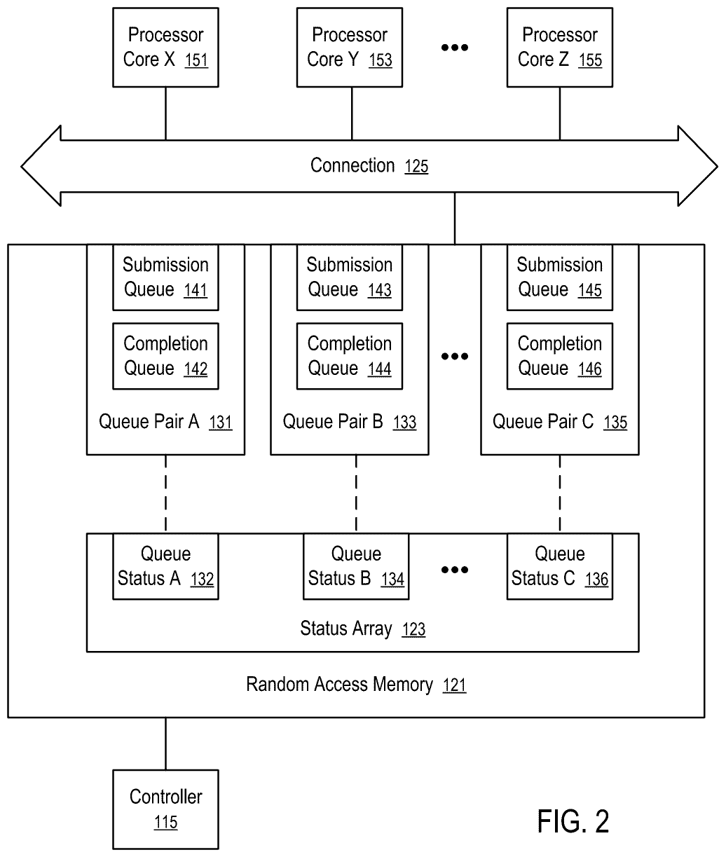

FIG. 2 shows an in-memory status array configured for a host system 102 to identify statues of submission queues to a memory sub-system 101 according to one embodiment. For example, the in-memory status array of FIG. 2 can be used in the computing system 100 of FIG. 1.

In FIG. 2, the host system 102 can have a plurality of processor cores 151, 153, . . . , and 155 that can provide commands for execution by the controller 115 of the memory sub-system 101 via submission queues 141, 143, . . . , and 145 configured in a random access memory 121. The processor cores 151, 153, . . . , and 155 can access the random access memory 121 via a connection 125 (e.g., a memory bus, a PCIe bus, etc.)

For example, the host system 102 can include a plurality of graphical processing units (GPUs), each having a plurality of GPU cores. Thus, the processor cores 151, 153, . . . , and 155 can be GPU cores running inference processes in parallel in an AI application. The memory sub-system 101 can store the AI/ANN model for the inference computations.

Each of the processor cores 151, 153, . . . , 155 can be assigned a dedicated queue pair (QP) (e.g., 131, 133, or 135). Each of the queue pairs (e.g., 131) can have a submission queue (e.g., 141) for a processor core (e.g., 151) to send commands for execution by the controller 115 of the memory sub-system 101 and a completion queue 142 to receive, from the memory sub-system 101, completion messages about the execution of the commands retrieved from the submission queue (e.g., 141).

The random access memory 121 is configured to be accessible to both the processor cores 151, 153, . . . , 155 of the host system 102 and the controller 115 of the memory sub-system 101.

Each of the queues (e.g., 141, 143, . . . , 145; 142, 144, . . . , 146) can be configured in a cyclic buffer allocated from the random access memory 121 (e.g., according to a standard of NVMe). For example, the submission queue 141 can be in a cyclic buffer having a predetermined number of slots for commands, where each slot has a same predetermined size to hold one command. A processor core (e.g., 151) can add one or more commands to the end of a submission queue (e.g., 141) in the cyclic buffer for retrieval by the controller 115 of the memory sub-system 101 at a time decided by the memory sub-system 101.

The random access memory 121 can further include a status array 123 configured with a number of slots that is equal to the number of queue pairs 131, 133, . . . , 135. Each slot in the array 123 is configured for a respective submission queue. For example, a slot in the array 123 is configured to store the queue status 132 of the submission queue 141; another slot in the array 123 is configured to store the queue status 134 of the submission queue 143; and a further slot in the array 123 is configured to store the queue status 136 of the submission queue 145.

After a processor core (e.g., 151, 153, or 155) appends one or more commands to its dedicated submission queue (e.g., 141, 143, or 145), the processor core (e.g., 151, 153, or 155) can update the queue status (e.g., 132, 134, or 136) in the respective slot of the status array 123.

A queue manager 113 in the controller 115 of the memory sub-system 101 can determine the status (e.g., 132, 134, or 136) of a submission queue (e.g., 141, 143, or 145) efficiently by reading the content of a respective slot in the array 123, without having to search or check the content in the respective submission queue (e.g., 141, 143, or 145).

Each queue status (e.g., 132, 134, or 136) can be configured to indicate the number of commands in the respective submission queue (e.g., 141, 143, or 145), and/or the number of commands added to the queue (e.g., 141, 143, or 145) since the last check of the status (e.g., 132, 134, or 136).

For example, the queue status (e.g., 132, 134, or 136) can include the identification of a position of the last command in the cyclic buffer hosting the respective submission queue (e.g., 141, 143, or 145).

For example, the queue status (e.g., 132, 134, or 136) can include a TagID of the last command added in the respective submission queue (e.g., 141, 143, or 145).

In some implementations, the maximum of a TagID just before it rolls over back to zero is equal to the number of slots in the cyclic buffer hosting the respective submission queue (e.g., 141, 143, or 145). In other implementations, the maximum of a TagID can be larger than the number of slots in the cyclic buffer hosting the respective submission queue (e.g., 141, 143, or 145).

Optionally, a queue status (e.g., 132, 134, or 136) can include the positions or TagIDs of both the command at the beginning and the command at the end in the respective submission queue (e.g., 141, 143, or 145).

For example, after the memory sub-system 101 completes execution of some of the commands from the beginning of the submission queue (e.g., 141, 143, or 145), the memory sub-system 101 can update the queue status (e.g., 132, 134, or 136) of the queue (e.g., 141, 143, or 145) to include the position or TagID of the command at the new beginning of the queue (e.g., 141, 143, or 145).

For example, after the host system 102 receives completion messages from a completion queue (e.g., 142, 144, or 146), the host system 102 can update the queue status (e.g., 132, 134, or 136) of the respective submission queue (e.g., 141, 143, or 145) to include the position or TagID of the command at the new beginning of the queue (e.g., 141, 143, or 145).

Optionally, after the controller 115 checks the status array 123, the controller 115 updates the queue statuses 132, 134, . . . , 136 to save the positions or TagIDs of the last commands in the submission queues 141, 143, . . . , 145 as the positions or TagIDs at the time of last checking the array 123, such that subsequent updates of the positions or TagIDs of the last commands in the submission queues 141, 143, . . . , 145 can be compared to the last checked values to determine the amounts of new commands added between the checking of the status array 123.

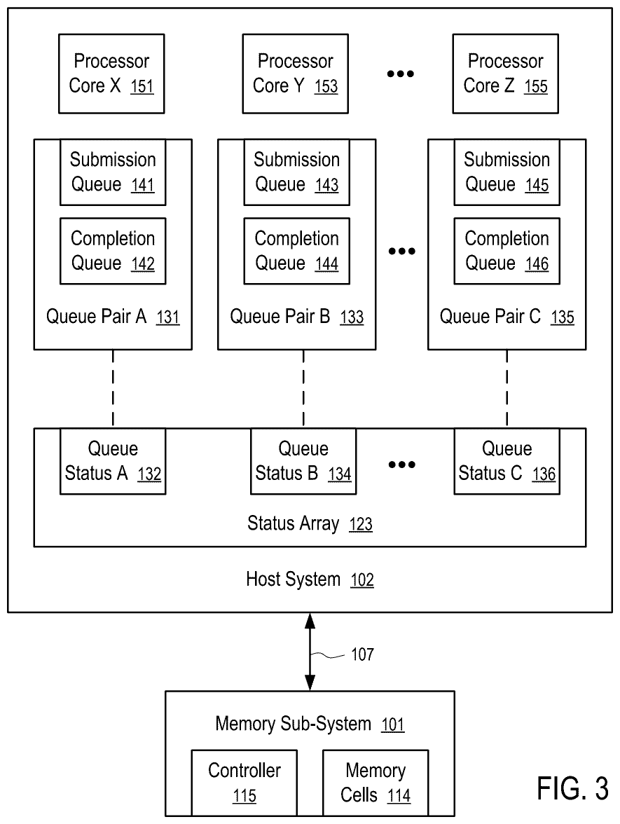

In general, there can be different ways to configure the random access memory 121 to host the queue pairs 131, 133, . . . , 135 and the status array 123, as illustrated in FIG. 3 to FIG. 6.

FIG. 3 to FIG. 6 show different configurations of in-memory status arrays and queue pairs configured according to some embodiments. For example, the queue pairs 131, 133, . . . , 135 and the status array 123 discussed in connection with the random access memory 121 of FIG. 2 can be configured in different ways as illustrated in FIG. 3 to FIG. 6.

For example, in some implementations, the random access memory 121 of FIG. 2 is configured in the host system 102; and the queue manager 113 in the controller 115 of the memory sub-system 101 is configured to access the queue pairs 131, 133, . . . , 135 and the status array 123 over a connection (e.g., a computer bus 107, such as a PCIe bus) between the host system 102 and the memory sub-system 101, as illustrated in FIG. 3.

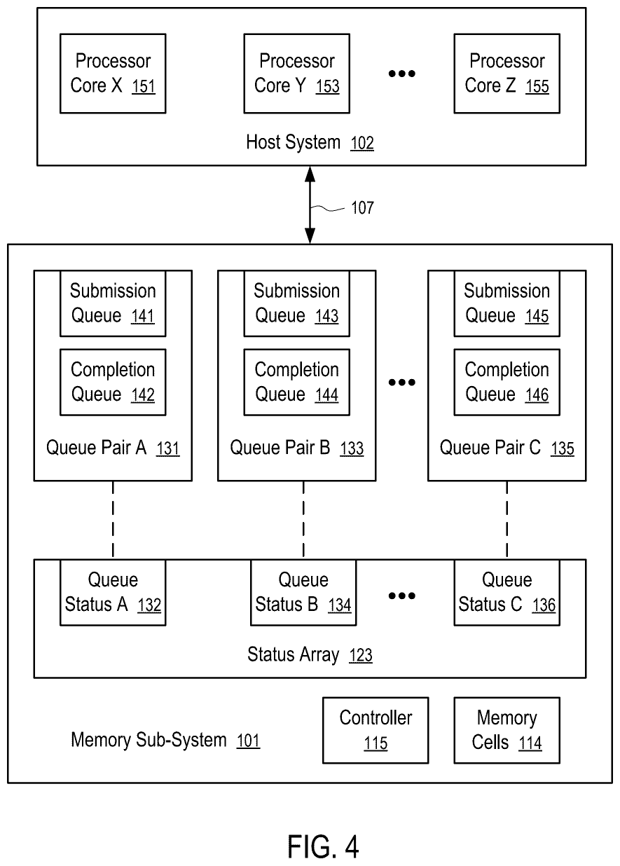

For example, in some implementations, the random access memory 121 of FIG. 2 is configured in the memory sub-system 101; and the processor cores 151, 153, . . . , 155 of the host system 102 are configured to access the queue pairs 131, 133, . . . , 135 and the status array 123 over a connection (e.g., a computer bus 107, such as a PCIe bus) between the host system 102 and the memory sub-system 101, as illustrated in FIG. 4.

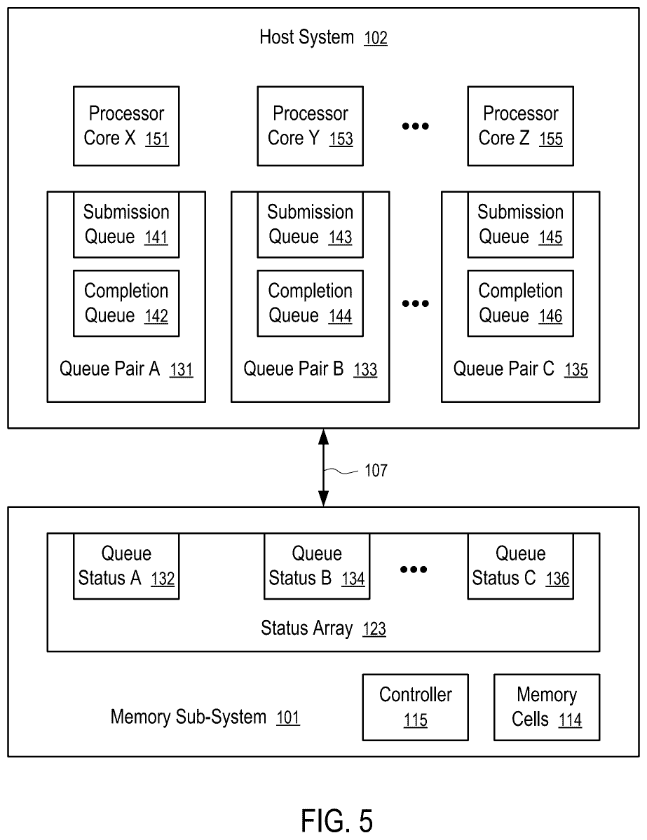

For example, in some implementations, the random access memory 121 of FIG. 2 can have a portion configured in the memory sub-system 101 to host the status array 123 and another portion configured in the host system 102 to host the queue pairs 131, 133, . . . , 135; the queue manager 113 in the controller 115 of the memory sub-system 101 is configured to access the queue pairs 131, 133, . . . , 135 over a connection (e.g., a computer bus 107, such as a PCIe bus) between the host system 102 and the memory sub-system 101; and the processor cores 151, 153, . . . , 155 of the host system 102 are configured to access the status array 123 over the connection (e.g., a computer bus 107, such as a PCIe bus) between the host system 102 and the memory sub-system 101, as illustrated in FIG. 5.

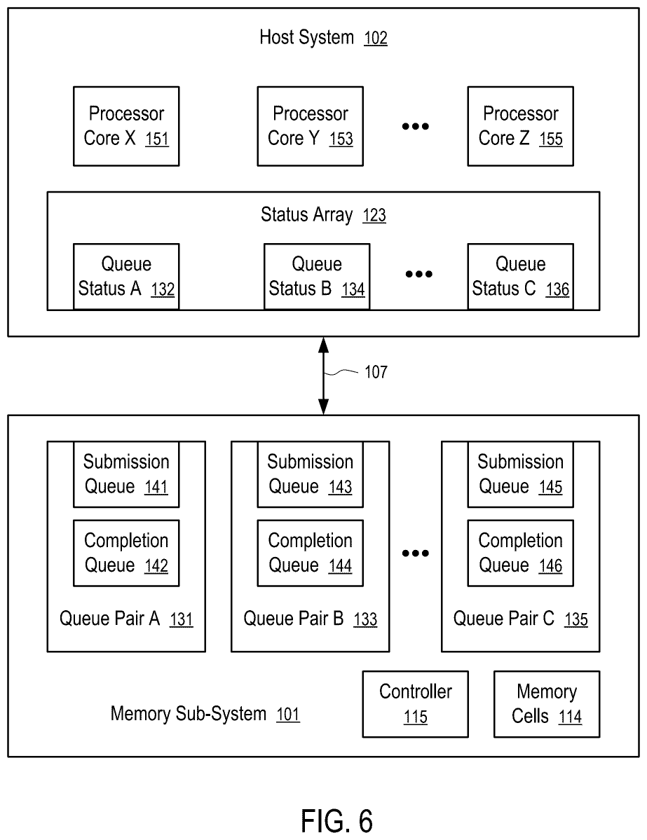

For example, in some implementations, the random access memory 121 of FIG. 2 can have a portion configured in the host system 102 to host the status array 123 and another portion configured in the memory sub-system 101 to host the queue pairs 131, 133, . . . , 135; the queue manager 113 in the controller 115 of the memory sub-system 101 is configured to access the status array 123 over a connection (e.g., a computer bus 107, such as a PCIe bus) between the host system 102 and the memory sub-system 101; and the processor cores 151, 153, . . . , 155 of the host system 102 are configured to access the queue pairs 131, 133, . . . , 135 over the connection (e.g., a computer bus 107, such as a PCIe bus) between the host system 102 and the memory sub-system 101, as illustrated in FIG. 6.

for example, in some implementations, the status array 123 of FIG. 2 can have a plurality of portions configured to track different aspects of the statuses 132, 134, . . . , 136. For example, one aspect can be the positions or TagIDs of commands at the beginning positions of the submission queues 141, 143, or 145; another aspect can be the positions or TagIDs of last commands at the ending positions of the submission queues 141, 143, or 145; and a further aspect can be the positions or TagIDs of last commands at the ending positions of the submission queues 141, 143, or 145 at the time of the queue manager 113 last checking the status array 123. Optionally, some of the portions can be configured in the host system 102; and the other portions can be configured in the memory sub-system 101.

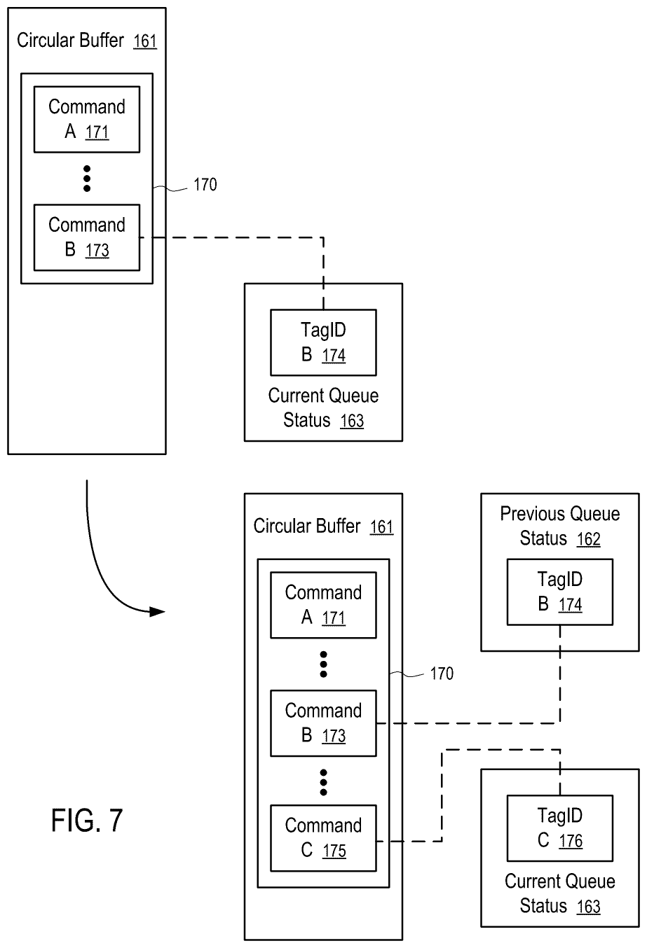

FIG. 7 illustrates a technique of using command TagID to identify queue statuses according to one embodiment. For example, the queue statuses 132, 134, . . . , 136 in FIG. 2 to FIG. 6 can be implemented using the technique of FIG. 7.

In FIG. 7, a circular buffer 161 (e.g., allocated from a random access memory 121 of FIG. 2) is configured with a predetermined number of slots for commands (e.g., 171, . . . , 173) in a submission queue 170 (e.g., 141, 143, . . . , or 145 in FIG. 2 to FIG. 6). Each slot has a fixed size and is configured to store one command (e.g., 171 or 173).

For example, the circular buffer 161 can be structured to hold a submission queue 170 in a way as specified by a standard of non-volatile memory express (NVMe).

Commands are added to the end of the queue 170 in the circular buffer 161 sequentially; and the last command added to the queue 170 represents the end of the queue 170. Commands are removed from the beginning of the queue 170; and the earliest command remaining in the queue 170 represents the beginning of the queue 170. Thus, which slot in the circular buffer 161 stores the command representing the beginning of the queue 170 and which slot in the circular buffer 161 stores the command representing the end of the queue 170 can change as commands are added at the end of the queue 170 and removed from the beginning of the queue 170.

A command (e.g., 173) can be assigned a TagID (e.g., 174). TagID increases by one for each command added to the queue 170 in the circular buffer 161. Thus, the TagID of a command represents a sequence number of the command among commands added to the queue 170. When the TagID of a command reaches a predetermined maximum (e.g., 64K), the TagID of the next command added to the queue 170 can roll over to take the value of zero. When the predetermined maximum corresponds to the number of slots in the circular buffer 161, the TagID also identifies a position of the slot in which the command is specified.

In FIG. 7, when the command 173 is added as the last command in the queue 170 in the circular buffer 161, the TagID 174 of the command 173 can be stored in the status array 123 as the current queue status 163 of the queue 170. If the circular buffer 161 is previously known to start with a command 171 having a TagID that is equal to zero, the queue manager 113 in the memory sub-system 101 can determine that the number of commands in the queue 170 is the TagID 174 plus one, which also corresponds to the number of new commands added since the circular buffer 161 is last checked or set up as having an empty queue.

After retrieving the TagID 174 from the status array 123 for the queue, the queue manager 113 in the memory sub-system 101 can store it as the previous queue status 162 of the queue 170.

Subsequently, the host system 102 can add more commands (e.g., 175) to the queue and update the current queue status 163 to show the TagID 176 of the last command 175 in the queue 170.

When the queue manager 113 in the memory sub-system 101 retrieves the current queue status 163 from the status array 123, the queue manager 113 can compare the TagID 176 of the current last command 175 in the queue 170 with the TagID 174 stored as previously queue status 162. The difference represents the number of new commands added in the time period between when the TagID 174 is retrieved previously, and when the TagID 176 is retrieved currently.

For example, based on how many commands are added since the last check of the status array 123, the queue manager 113 in the memory sub-system 101 can determine a distribution of workloads of the submission queues 141, 143, . . . , and 145, which can correspond to the input/output workloads of the respective processing cores 151, 153, . . . , 155. Based on the workload distribution, the memory sub-system 101 can prioritize the processing of submission queues 141, 143, . . . , 145 and allocate the processing resources for command execution across the submission queues 141, 143, . . . , 145.

Alternatively, or in combination, the queue manager 113 can be configured to store the TagID of the command 171 positioned at the beginning of the queue 170. As commands are removed from the beginning of the queue 170, the memory sub-system 101 (or the host system 102) can update the TagID of the command that is currently at the beginning of the queue 170. A comparison of the TagID of the command 171 at the beginning of the queue 170 and the TagID of the command 175 at the end of the queue 170 can be used to determine the amount of pending commands 171, . . . , 175 in the queue 170. Based on how many commands are pending in the submission queues 141, 143, . . . , and 145, the queue manager 113 in the memory sub-system 101 can determine a distribution of workloads of the submission queues 141, 143, . . . , and 145.

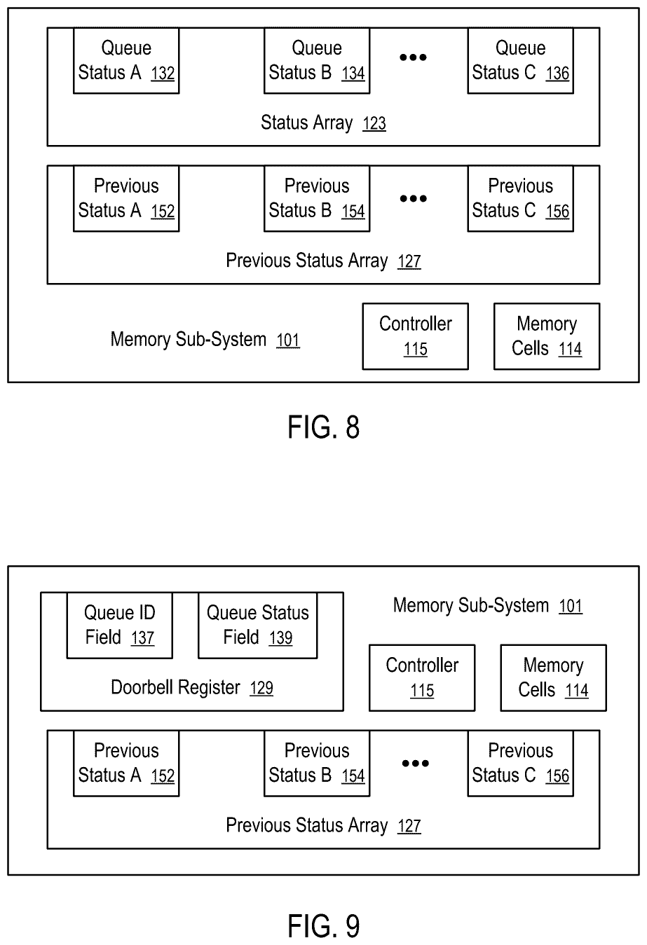

FIG. 8 shows a memory sub-system configured to determine the amounts of commands in submission queues according to one embodiment. For example, the memory sub-system of FIG. 8 can be used in the computing system 100 of FIG. 1 in combination of the techniques discussed above in connection with FIG. 2 to FIG. 7.

In FIG. 8, the memory sub-system 101 is configured to store a previous status array 127 having a plurality of slots configured to store previous statuses 152, 154, . . . , 156 of submission queues (e.g., 141, 143, . . . , 145 as configured in FIG. 2 to FIG. 6).

For example, each of the previous queue status (e.g., 152, 154, or 156) can be a previous TagID of the last command in a respective queue (e.g., 141, 143, or 145), like the TagID 174 for the previously last command 173 recorded in the previous queue status 162 in FIG. 7 for the queue 170.

A difference between a previous status (e.g., 152, 154, or 156) in the previous status array 127 and a corresponding queue status (e.g., 132, 134, or 136) for a same submission queue (e.g., 141, 143, or 145) can be used by the queue manager 113 in the memory sub-system 101 to determine the amount of new commands added to the queue (e.g., 141, 143, or 145) between when the previous status array 127 is last updated and when the status array 123 is currently retrieved, or examined.

In some implementations, the processor cores 151, 153, . . . , 155 of the host system 102 are configured to update the status array 123 configured in the memory sub-system 101 after adding commands to their respective submission queues 141, 143, . . . , 145 (e.g., as in FIG. 4 and FIG. 5).

In other implementations, the processor cores 151, 153, . . . , 155 of the host system 102 are configured to update the status array 123 configured in the host system 102 (e.g., as in FIG. 3 and FIG. 6). When the queue manager 113 in the memory sub-system 101 decides to check the numbers of new commands added to the submission queues 141, 143, . . . , 145, the memory sub-system 101 can retrieve a copy of the status array 123 from the host system 102 for comparing with the previous status array 127.

After determining the amounts of new commands in the submission queues 141, 143, . . . , 145, the queue manager 113 can replace the previous status 152, 154, . . . , 156 in the previous status array 127 with the corresponding queue status 132, 134, . . . , 136 from the status array 123.

Optionally, the queue manager 113 can select a subset of submission queues 141, 143, . . . , 145 for processing (e.g., based on the distribution of amounts of commands determined from comparing the status array 123 and the previous status array 127). The queue manager 113 can update the previous status (e.g., 152) of a submission queue (e.g., 141) selected for processing without updating the previous status (e.g., 154) of a submission queue (e.g., 143) not selected for processing.

Alternatively, or in combination, the memory sub-system 101 is configured to store an array of TagIDs of commands at the beginning of the submission queues 141, 143, . . . , 145. Comparing the array with the status array 123 can be used to determine the amounts of pending commands in the respective submission queues 141, 143, . . . , 145. After processing selected amounts of commands from a selected subset of the submission queues, the queue manager 113 can update the array of TagIDs of commands currently at the beginning of the submission queues 141, 143, . . . , 145.

FIG. 9 illustrates a doorbell register according to one embodiment. For example, the technique of FIG. 9 can be used in the computing system 100 of FIG. 1 and optionally in combination of the techniques discussed above in connection with FIG. 2 to FIG. 8.

In FIG. 9, the memory sub-system 101 includes a doorbell register 129 that has a queue ID field 137 and a queue status field 139. When a processor core (e.g., 151) decides to explicitly request the memory sub-system 101 to execute commands in its submission queue (e.g., 141), the processor core (e.g., 151) can write to the doorbell register 129 to identify its submission queue (e.g., 141) using the queue ID field 137 and to identify the current queue status 163 of its submission queue (e.g., 141) using the queue status field 139.

In response to a write to the doorbell register 129, the queue manager 113 can determine whether to adjust execution priority in view of the queue status 163 provided in the field 139 for the submission queue (e.g., 141) identified in the doorbell register 129.

In some implementations, the memory sub-system 101 has an in-memory status array 123 (e.g., as in FIG. 4, FIG. 5, and/or FIG. 8). In response to the write to the doorbell register 129, the queue manager 113 is configured to update the corresponding slot of the status array 123 for the queue identified via the queue ID field 137 in the doorbell register 129 to include the status provided in the field 139.

Optionally, the host system 102 has the option to update the slot in the status array 123 for the queue via writing to the centralized doorbell register 129 and the option to write directly to the individual slot in the status array 123 allocated from a random access memory (e.g., local memory 119) in the memory sub-system 101. When the host system 102 writes directly to the status array 123 in the memory sub-system 101, the queue manager 113 can postpone processing of the information until the next time to check the status array 123. When the host system 102 writes to the doorbell register 129, the memory sub-system 101 can respond sooner without waiting for the next time to check the status array 123 as a whole.

Optionally, after processing the content in the doorbell register 129, the queue manager 113 in the memory sub-system 113 can update the previous status array 127 by overwriting the currently stored previously status (e.g., 152, 154, or 156) of the queue identified by the queue ID field 137 with the content in the queue status field 139 of the doorbell register 129.

In an alternative embodiment, the host system 102 is not allowed to write directly to the status array 123 in the memory sub-system 101. To provide queue statuses (e.g., 132, 134, . . . , 136) to the memory sub-system 101, the host system 102 can write to the doorbell register 129. The memory sub-system 101 can track the time sequence of the requests for the respective submission queues and consider the time sequence (and/or the frequencies of the requests) in prioritizing the queues for servicing. For example, queues that have earlier requests and/or more frequent requests can be provided with higher priorities in servicing.

In some implementations, the host system 102 is configured with an in-memory status array 123 (e.g., as in FIG. 3 and FIG. 6). The host system 102 can update the status array 123 without using the connection (e.g., computer bus 107) between the host system 102 and the memory sub-system 101. Writing to the status array 123 in the host system 102 does not prompt the memory sub-system 101 to process the commands; and the queue manager 113 in the memory sub-system 101 can periodically read the status array 123 over the connection (e.g., a PCIe bus 107) between the host system 102 and the memory sub-system 101 to discover the queue statuses provided in the array 123. However, writing to the doorbell register 129 can ring the doorbell to prompt the queue manager 113 to reconsider command processing strategies, and/or assign higher priorities to queues identified via the doorbell register 129. Thus, the host system 102 (and the processor cores 151, 153, . . . , 155 running in the host system 102) can throttle requests to the memory sub-system 101 via a combined use of the status array 123 and the doorbell register 129 to convey the relative urgency or priority of the different submission queues 141, 143, . . . , 145.

Alternatively, or in combination with a status array 123 and/or a doorbell register 129, the computing system 100 can configure a cycle buffer to host a status queue in a way similar to hosting a submission queue. Each slot in the status queue can be configured to hold the doorbell content illustrated in FIG. 9 in connection with the doorbell register 129. The processor cores 151, 153, 155 can optionally submit their doorbell register content in the status queue directly such that the timing of the requests from the processor cores are identified in the order of doorbell entries listed in the status queue. The queue manager 113 can use the timing of the doorbell entries and the quantities of commands indicated by the queue statues in the doorbell entries to prioritize the processing of submission queues and their commands.

In some implementations, the host system 102 is not allowed to add entries to the status queue directly. When the host system 102 writes to the doorbell register 129, the queue manager 113 adds the content of the doorbell register 129 as a new entry in the status queue.

A combination of the status array 123, the doorbell register 129, and/or the status queue can be used to provide rich information about the commands in the submission queues 141, 143, . . . , 145. Such information can be useful to the queue manager 113 in scheduling command retrieval and execution. Such information can include how many commands are pending in the submission queues 141, 143, . . . , 145, how many new commands are added to the submission queues 141, 143, . . . , 145 in a recent time period, how frequently requests are made to execute commands in specific submission queues (e.g., 141, 143, or 145), how the requests to execute commands for the submission queues (e.g., 141 or 143) are relative to each other in time, etc.

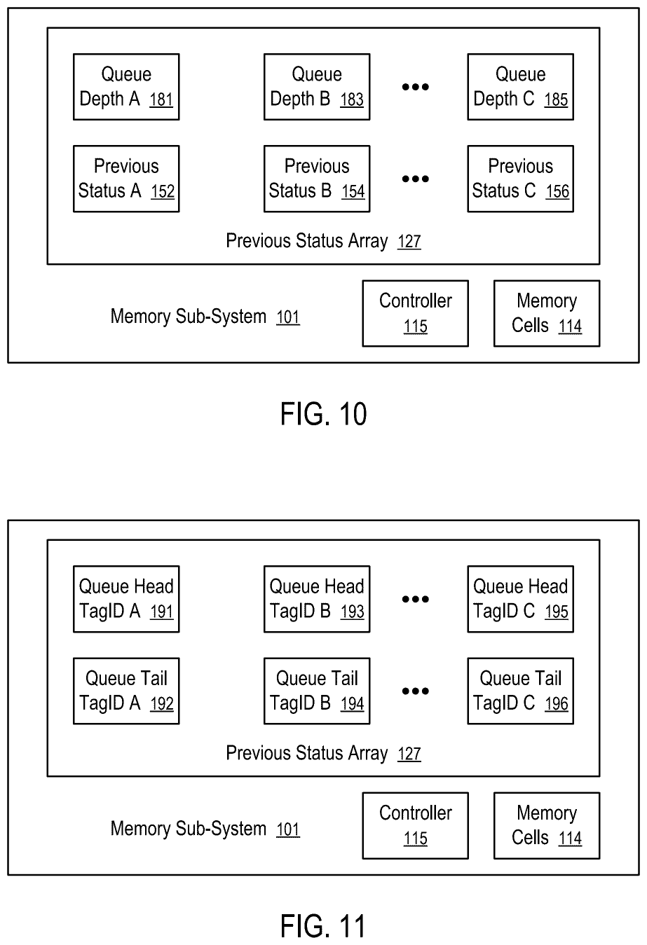

FIG. 10 and FIG. 11 show information tracked by a queue manager in a memory sub-system to schedule command retrieval and execution according to some embodiments. For example, the queue manager 113 in the memory sub-system 101 of FIG. 1 can be configured to track the information shown in FIG. 10 and/or FIG. 11 to schedule command retrieval from submission queues 141, 143, . . . , 145 in FIG. 2.

In FIG. 10, the previous status array 127 in the memory sub-system 101 is configured to track not only the previous statuses 152, 154, . . . , 156 for respective submission queues 141, 143, . . . , 145 (e.g., as discussed above in connection with FIG. 7 to FIG. 9), but also the queue depths 181, 183, . . . , 185 of the respective submission queue 141, 143, . . . , 145. A queue depth (e.g., 181, 183, or 185) identifies the number of pending commands queued in the respective submission queue (e.g., 141, 143, or 145) before the command identified via the corresponding previous status (e.g., 152, 154, or 156).

Optionally, the memory sub-system 101 can execute commands in a submission queue (e.g., 141, 143, or 145) out of order. After execution of some commands in a submission queue (e.g., 141, 143, or 145), the queue manager 113 can reduce the respective queue depth (e.g., 181, 183, or 185) by the number of commands having been executed. Thus, the queue manager 113 can determine accurately an amount of commands in the submission queue (e.g., 141, 143, or 145) without having to check the corresponding queue pair (e.g., 131, 133, or 135).

In some implementations, the memory sub-system 101 is configured to retrieve commands from a submission queue (e.g., 141, 143, or 145) for execution sequentially, starting from the beginning of the submission queue (e.g., 141, 143, or 145). Thus, an amount of commands in the submission queue (e.g., 141, 143, or 145) can be determined based on the TagID of the command at the beginning of the submission queue (e.g., 141, 143, or 145).

For example, in FIG. 11, the previous status array 127 identifies not only the TagIDs 192, 194, . . . , 196 of the last commands in the respective submission queues 141, 143, . . . , 145 at the time of the previous checking of the status array 123, but also the TagIDs 191, 193, . . . , 195 of the first commands in the respective submission queues 141, 143, . . . , 145. For example, the queue head TagID 191 is specified for the command at the beginning of the respective submission queue 141; and the queue tail TagID 192 is specified for the command at the end of the submission queue 141 at the time of last checking of the status array 123 (or the doorbell register 129, or a status queue). When the retrieval of commands from the submission queue 141 is sequential, the difference between the queue head TagID 191 and the queue tail TagID 192 can be used to determine the number of commands between the respective queue head and queue tail. The queue head TagID 191 can be updated in response to command retrieval from the head/beginning of the submission queue; and the queue tail TagID 192 can be updated in response to checking the status array 123 (or the doorbell register 129, or a status queue). The difference between the previous queue tail TagID 192 and the current queue tail TagID (e.g., obtained from the status array 123, or the doorbell register 129, or a status queue) can be used to determine the number of new commands added to the submission queue 141.

In some implementations, the TagIDs (e.g., 191, 193, . . . , 195; 192, 194, . . . , 196) are configured to correspond to, or are replaced with, slot position identifications of the respective commands in the cyclical buffers hosting the submission queues 141, 143, . . . , 145.

In some implementations, the previous status array 127 can include further information, such as the timestamp of writing to the doorbell register 129 to request execution of commands for a respective submission queue identified via the queue ID field 137, or a queue position of the doorbell entry specified in the status queue for the submission queue.

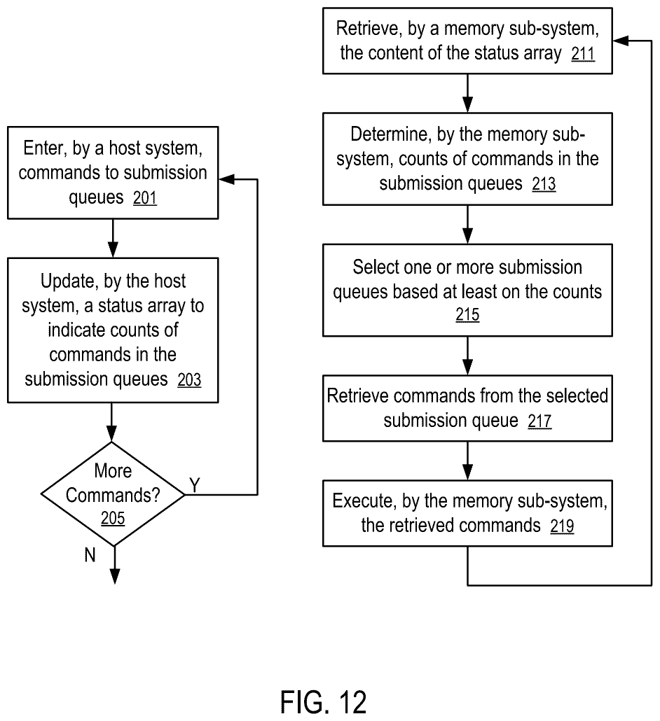

FIG. 12 to FIG. 15 show methods to manage queues of commands for execution in a memory sub-system according to one embodiment. The methods of FIG. 12 to FIG. 15 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the methods of FIG. 12 to FIG. 15 are performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the methods of FIG. 12 to FIG. 15 can be implemented in the computing system 100 of FIG. 1 to process commands in submission queues 141, 143, . . . , 145 in a way as discussed above in connection with FIG. 2 to FIG. 11.

At block 201, the method of FIG. 12 includes a host system 102 entering commands (e.g., 171, 173) to submission queues (e.g., 170; 141, 143, or 145).

For example, each submission queue (e.g., 170 or 141) can be configured in a cyclic buffer 161 having a predetermined number of slots for commands (e.g., 171, 173, 175). Each slot has a same predetermined size to hold a command (e.g., 171). The cyclic buffer 161 can be allocated from a random access memory 121 in the host system 102 (e.g., in FIG. 3 and FIG. 5), or a random access memory 121 in the memory sub-system 101 (e.g., in FIG. 4 and FIG. 6).

For example, operations on each submission queue (e.g., 170 or 141) (e.g., adding commands to or removing commands from the cyclic buffer 161) can be performed in accordance with a standard of non-volatile memory express (NVMe).

At block 203, the host system 102 updates a status array 123 to indicate counts of commands in the submission queues (e.g., 141, 143, . . . , 145).

For example, the status array 123 can be allocated, according to the number of submission queues 141, 143, . . . , 145, from a random access memory (e.g., 121) that is accessible to both the host system 102 and the memory sub-system 101. The random access memory hosting the status array 123 can be in the host system 102 (e.g., as in FIG. 3 and FIG. 6), or in the local memory system (e.g., as in FIG. 4 and FIG. 5). The status array 123 and the submission queues 141, 143, . . . , 145 can be in a same random access memory (e.g., in the host system 102 as in FIG. 3, or in the memory sub-system 101 as in FIG. 4), or in different random access memories (e.g., as in FIG. 5 and FIG. 6).

The status array 123 can have the same number of slots as the number of submission queues 141, 143, . . . , 145 such that each submission queue (e.g., 141, 143, or 145) has a dedicated slot for storing data indicative of the queue status (e.g., 132, 134, or 136) of the respective submission queue (e.g., 141, 143, or 145).

The host system 102 updating the status array 123 does not trigger the memory sub-system 101 to process the submission queues 141, 143, . . . , 145 and/or analyze the content of the status array 123. In some applications (e.g., AI/ANN inference computations), it can be rare that there are no commands left in the entire set of submission queues 141, 143, . . . , 145. When the host system 102 adds commands at block 201 and/or updates the status array 123 at block 203, the memory sub-system 101 can be in a time period of processing commands previously entered in the submission queues 141, 143, . . . , 145 and thus does not respond to the operations of the host system 102 at blocks 201 and 203, until the memory sub-system 102 is ready to identify a next batch of commands for execution after the execution of the current batch of commands.

When the host system 102 has more commands (e.g., 175) at block 205, the operations at blocks 201 and 203 can repeat.

For example, the host system 102 can have a plurality of processor cores 151, 153, . . . , 155. Each of the processor cores (e.g., 151, 153, or 155) can be assigned to one a dedicated queue pair (e.g., 131, 133, or 135) and its associated slot for queue status (e.g., 132, 134, or 136) in the status array 123. Thus, the processor cores 151, 153, . . . , 155 can operate substantially independent from each other without the need for a memory manager to lock queues for merging commands from different processor cores to a same submission queue; and the solution can scale up to service a large number of processor cores (e.g., more than 2048 or 100,000).

For example, the operations at block 201 and 203 can be performed by each processor cores 151, 153, . . . , 155 in a plurality of concurrent execution threads.

Independent from the host system 102 adding commands to submission queues 141, 143, . . . , 145, the memory sub-system 101 can perform operations at blocks 211 to 219 to identify commands for execution one batch at a time.

At block 211, the method of FIG. 12 includes the memory sub-system 101 retrieving the current content of the status array 123 to determine a batch of command for processing, after identifying and/or processing a previous batch of commands.

Optionally, the memory sub-system 101 can retrieve the entire content of the status array 123 for all of the submission queues 141, 143, . . . , 145. Alternatively, the memory sub-system 101 can retrieve and process a subset of the queue statuses 132, 134, . . . , 136 at a time. For example, the memory sub-system 101 can process different subsets according to a round robin scheme, or another scheme (e.g., randomly). The arrangement allows the solution to be scaled up to service a large number of submission queues (e.g., more than 2048 or 100,000).

At block 213, the memory sub-system 101 determines, based on the retrieved content of the status array 123, counts of commands in the submission queues 141, 143, . . . , 145.

For example, based on the retrieved content of the status array 123, the queue manager 113 in the memory sub-system 101 can determine a count of new commands added to a submission queue (e.g., 141) since the last check of the status of the submission queue, and/or a count of pending commands remaining in the submission queue (e.g., 141). For example, the count determination can be based on a TagID or command position provided in a current queue status 163 and a corresponding TagID or command position provided in a previous queue status 162, as discussed in connection with FIG. 7.

At block 215, the memory sub-system 101 selects one or more submission queues (e.g., 141 or 143) based at least on the counts determined at block 213.

For example, the memory sub-system 101 can be configured to process no more than a predetermined number of commands in a batch. Based on the counts determined at block 213, the memory sub-system 101 can distribute the workload of processing the predetermined number of commands for the batch to service one or more submission queues selected at block 215.

For example, a large portion of the workload can be allocated to a submission queue that has a large number of pending or newly added commands; and a small portion of the workload can be allocated to a submission queue that has a small number of pending or newly added commands.

At block 217, the memory sub-system 101 retrieves commands from the selected submission queue.

For example, the amounts of commands retrieved from the one or more submission queues selected at block 215 can be approximately in proportion with counts of pending and/or newly added commands in the selected queues.

At block 219, the memory sub-system 101 executes the retrieved commands.

After the processing (or the identification) of the current batch of commands, the memory sub-system 201 can repeat the operations at block 211 to identify a next batch of commands for execution.

When the memory sub-system 101 is configured to process commands in batches as in FIG. 12, it is not necessary for the host system 101 to ring the doorbell by writing to a doorbell register (e.g., 129) in the memory sub-system 101.

Optionally, the host system 101 can use the doorbell register 129 and/or a status queue to signal the priorities of submission queues 141, 143, . . . , 145.

For example, the host system 101 can be configured to prevent low priority inference processes in some of the processor cores 151, 153, . . . , 155 from writing to the doorbell register 129, while allowing high priority inference processes to write to the doorbell register 129. Thus, the queue manager 113 can use the priority hints provided via the use of the doorbell register 129 to optimize the scheduling of command execution in the memory sub-system 101.

Alternatively, or in combination, a status queue can be used to indicate the timing of requests posted in the submission queues. The queue manager 113 processing submission queues of equal or similar priorities based on the time sequence of requests indicated in the status queue.

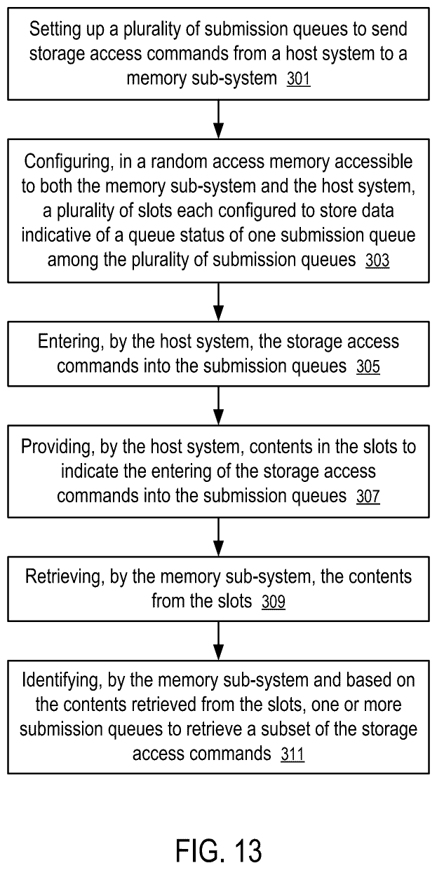

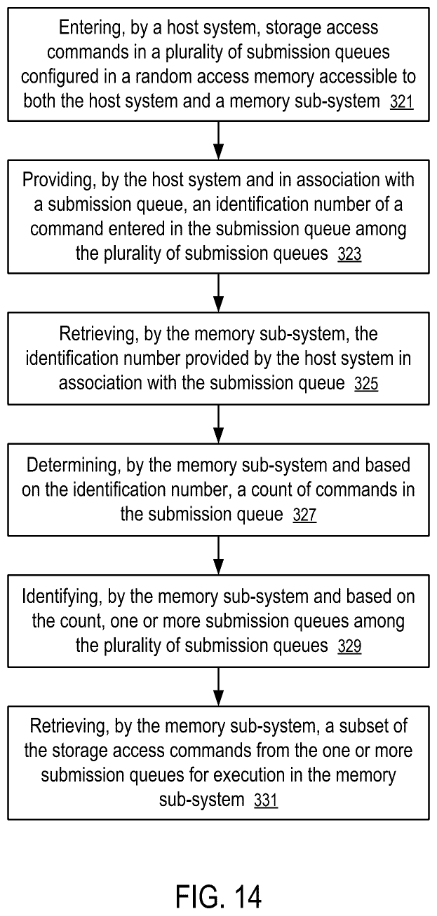

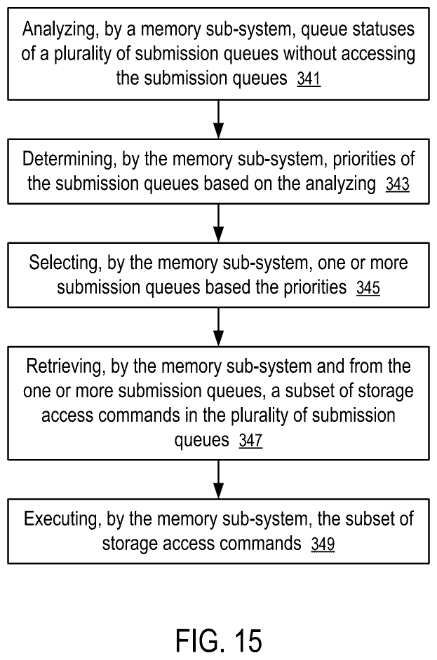

Optionally, the status array 123 can be configured and used in a way as in the method of FIG. 13; the counts of commands can be determined in a way as in the method of FIG. 14; and the batch processing of commands can be performed in a way as in the method of FIG. 15.

At block 301, the method of FIG. 13 includes setting up a plurality of submission queues 141, 143, . . . , 145 (e.g., 170 in a cyclic buffer 161) to send storage access commands (e.g., 171, 173, or 175) from a host system 102 to a memory sub-system 101 (e.g., as in FIG. 1 and FIG. 2).

For example, the memory sub-system 101 can have non-volatile memory cells 114 configured to provide a storage capacity of the memory sub-system 101 in serving the host system 102. The memory sub-system 101 can include a random access memory 121 accessible to the host system 102. The submission queues 141, 143, . . . , 145 can be configured in the random access memory 121 of the memory sub-system 101 (or, alternatively, in a random access memory 121 of the host system 102 that is accessible to the memory sub-system 101). The memory sub-system 101 can have at least one processor (e.g., processing device 117) configured to run instructions programmed to implement a queue manager 113 for the processing of commands in the submission queues 141, 143, . . . , 145.

For example, the host system 102 can include a plurality of processor cores 151, 153, . . . , 155 and a connection (e.g., computer bus 107) to the memory sub-system 101. The host system 102 can have a random access memory 121 accessible to the memory sub-system 101 to implement the submission queues 141, 143, . . . , 145. Alternatively, the submission queues 141, 143, . . . , 145 can be implemented in a random access memory of the memory sub-system 101. Optionally, each of the plurality of processor cores 151, 153, . . . , 155 can be assigned a separate, dedicated submission queue (e.g., 141, 143, or 145) (e.g., in an AI/ANN application).

At block 303, the method includes configuring, in a random access memory 121 accessible to both the memory sub-system 101 and the host system 102, a plurality of slots each configured to store data indicative of a queue status (e.g., 132, 134, or 136) of one submission queue (e.g., 141, 143, or 145) among the plurality of submission queues.

For example, each of the slots can have a same predetermined size to at least store a queue status (e.g., 163) in the form of a TagID 174 of the command 173 at the end of a submission queue (e.g., 170).

For example, the status array 123 can be configured in a same random access memory 121 as the queue pairs 131, 133, . . . , 135 (e.g., in FIG. 3 or FIG. 6), or in a different random access memory 121 (e.g., in FIG. 4 or FIG. 5).

For example, the plurality of slots in the status array 123 can correspond to the plurality of submission queues 141, 143, . . . , 145 respectively such that each of the plurality of slots is reserved to store data indicative of a queue status of a predetermined one of the plurality of submission queues 141, 143, . . . , 145. Thus, it is not necessary to store data in the slot to identify the submission queue for which the slot stores the queue status. A count of the slots in the status array 123 is equal to a count of the submission queues 141, 143, . . . , 145 configured for the host system 102 to access the memory sub-system 101.

In some implementations, the slots are configured in a cyclic buffer allocated from the random access memory 121. A count of the slots in the cyclic buffer can be smaller than a count of the submission queues 141, 143, . . . , 145. Each slot is configured with a field to identify a queue status and another field to identify a submission queue for which the queue status is stored in the slot. The cyclic buffer can be used to host a status queue (e.g., in a way similar to a cyclic buffer 161 hosting a submission queue 170). For example, the content in a slot can be similar to the content in a doorbell register 129 illustrated in FIG. 9. For example, the doorbell register 129 in the memory sub-system 101 can be configured to have a size same as a slot size of the plurality of slots; and in response to the host system 101 writing to the doorbell register 129, the queue manager 113 in the memory sub-system 101 can determine whether to change the priority of executing commands and/or copy the content of the doorbell register 129 for insertion as an entry at the end of the status queue in the cyclic buffer.

At block 305, the method includes entering, by the host system 102, the storage access commands (e.g., 171, 173) into the submission queues (e.g., 170).

At block 307, the method includes providing, by the host system 102, contents in the slots (e.g., current queue status 163) to indicate the entering of the storage access commands into the submission queues (e.g., 141, 143, or 145).

For example, each of the submission queues 141, 143, . . . , 145 can be assigned to only one of the processor cores 151, 153, . . . , 155 to submit commands for execution in the memory sub-system 101. The plurality of slots in the status array 123 can correspond to the plurality of submission queues 141, 143, . . . , 145 respectively such that each of the plurality of slots is assigned to only one of the submission queues (e.g., 141) to store data indicative of a queue status (e.g., 132) of a respective submission queue (e.g., 141).

Thus, the processing cores 151, 153, . . . , 155 in the host system 102 can separately use their respective submission queues 141, 143, . . . , 145 to add commands and their slots in the status array 123 to update their respective queue statuses 132, 134, . . . , 136 without a need for a mechanism to intercept their calls to use submission queues in order to merge their commands into shared submission queues.

At block 309, the method includes retrieving, by the memory sub-system 101, the contents from the slots (e.g., queue status 132, 134, or 136).

At block 311, the method includes identifying, by the memory sub-system 101 and based on the contents retrieved from the slots, one or more submission queues to retrieve a subset of the storage access commands (e.g., as in FIG. 12 for the retrieval and execution of a batch of commands).

For example, each of the plurality of slots can be configured to at least store an integer configured to identify a sequence number (e.g., TagID in FIG. 7) of a command (e.g., 173) entered at an end of a respective submission queue (e.g., 170).

For example, the plurality of slots can be configured as a status array 123 in the random access memory 121 at a time of booting up the host system 102 and in accordance with a count of the plurality of submission queues 141, 143, . . . , 145 set up at the boot time.

At block 321, the method FIG. 14 includes entering, by a host system 102 (e.g., in FIG. 1), storage access commands (e.g., 171, 173) in a plurality of submission queues (e.g., 141, 143, . . . , 145, such as queue 170) configured in a random access memory 121 accessible to both the host system 102 and a memory sub-system 101 (e.g., in FIG. 1).

For example, the host system 102 can have a plurality of processor cores 151, 53, . . . , 155, such as a plurality of GPUs, each having a plurality of GPU cores. The host system 102 can have a connection (e.g., a PCIe bus 107) to the memory sub-system 101 to perform inference computations based on model data stored in the memory sub-system 101.

For example, each respective processor core (e.g., 151, 153, or 155) among the plurality of processor cores can have a dedicated submission queue (e.g., 141, 143, or 145). The respective processor core (e.g., 151, 153, or 155) can enter storage access commands into its dedicated submission queue (e.g., 141, 143, or 145). After entering one or more commands in the queue (e.g., 141, 143, or 145), the respective processor core (e.g., 151, 153, or 155) can provide, in association with the submission queue, the identification number (e.g., TagID 174 or 176) of a command (e.g., 173 or 175) entered at the end in the submission queue (e.g., 170). Identification number provided in association with the submission queue (e.g., 170) allows the memory sub-system to determine a count of commands (e.g., 171, . . . 173; or 173, . . . , 175) in the submission queue (e.g., 170).

At block 323, the method includes providing, by the host system 102 and in association with a submission queue (e.g., 170), an identification number (e.g., TagID 174 or 176) of a command (e.g., 173, or 175) entered in the submission queue (e.g., 170) among the plurality of submission queues (e.g., 141, 143, . . . , 145).

For example, the method can further include: tracking, by the host system, a respective identification number (e.g., TagID) of each respective command entered into the submission queue 170 by increasing by one an identification number of a command entered into the same submission queue 170 before the respective command. Thus, an identification number (e.g., TagID) of a command corresponds to a sequence number of the command in the submission queue 170. The sequence number can have a predetermined maximum. The host system can roll the sequence number to zero once it reaches the predetermined maximum.

In some implementations, the predetermined maximum is equal to a number of slots in a cyclic buffer 161 configured to host the submission queue 170. Thus, the sequence number of a command (e.g., 173) can correspond to a slot number of the slot that stores the command (e.g., 173).

In other implementations, the predetermined maximum can be larger than a number of slots in a cyclic buffer 161 configured to host the submission queue 170. Thus, the sequence number of a command (e.g., 173) may not correspond to the slot number of the slot that stores the command (e.g., 173).

For example, to provide the identification number (e.g., TagID) in association with a particular submission queue (e.g., 141, 143, or 145), the host system 101 can write the identification number (e.g., TagID as current queue status) in a slot in a status array 123. The array 123 can have a plurality of slots, each for the host system 102 (e.g., processor cores 151, 152, . . . , 155) to store the current queue status (e.g., 132, 134, or 146) for a respective submission queue (e.g., 141, 143, or 145). Thus, the host system 102 is configured to write the TagID to the slot that is pre-associated with the submission queue 170 among the plurality of submission queues 141, 143, . . . , 145 to indicate that the TagID is for the last command in the submission queue 170.

Alternatively, or in combination, the host system 102 can provide the identification number (e.g., TagID) in association with the submission queue (e.g., 170) by writing the identification number (e.g., TagID) and an identification of the submission queue (e.g., 170) in a doorbell register 129 in the memory sub-system 101. The doorbell register 129 can have a predetermined PCIe address that is independent of the submission queue 170. Writing to the doorbell register 129 can be considered by the memory sub-system 101 as a more urgent request to execute commands in the submission queue (e.g., 170) than an implicit request to execute the commands made via writing to the status array 123.

Alternatively, or in combination, the host system 102 can provide the identification number (e.g., TagID) in association with the submission queue (e.g., 170) by adding an entry into a status queue. The entry being added to the status queue can include the identification number (e.g., TagID) and an identification of the submission queue (e.g., 170). For example, the status queue can be configured in a cyclic buffer and can have a fewer count of slots than a count of the submission queues 141, 143, . . . , 145. For example, the slots can have a same predetermined size; and each slot is configured to hold a status queue entry having a content formatted in a same way as the content of the doorbell register 129.

At block 325, the method includes retrieving, by the memory sub-system 101, the identification number (e.g., TagID 174 or 176) provided by the host system 102 in association with the submission queue (e.g., 170).

At block 327, the method includes determining, by the memory sub-system 101 and based on the identification number (e.g., TagID 174 or 176), a count of commands (e.g., 171, . . . , 173; or 173, . . . , 175) in the submission queue (e.g., 170).

For example, the command can be a second command 175; the identification number of the command is an identification number (e.g., TagID 176) of the second command; and the method further includes: tracking, by the memory sub-system 101 using a previous status array 127 and for the submission queue 170, an identification number of a first command (e.g., 173) entered in the submission queue 170 prior to the addition of the second command (e.g., 175) into the submission queue 170. A count of commands in the submission queue 170 can be computed based on a difference between the identification number (e.g., TagID 174) of the first command (e.g., 173) and the identification number (e.g., TagID 176) of the second command (e.g., 175).

At block 329, the method includes identifying, by the memory sub-system 101 and based at least in part on the count (e.g., TagID 174 or 176), one or more submission queues among the plurality of submission queues (e.g., 141, 143, . . . , 145).

At block 331, the method includes retrieving, by the memory sub-system 101, a subset of the storage access commands from the one or more submission queues for execution in the memory sub-system 101.

At block 341, the method of FIG. 15 includes analyzing, by a memory sub-system 101 (e.g., in FIG. 1), queue statuses (e.g., 132, 134, . . . , 136 in FIG. 2) of a plurality of submission queues (e.g., 141, 143, . . . , 145) without accessing the submission queues (e.g., 141, 143, . . . , 145).

For example, the method can further include: retrieving, by the memory sub-system 101, the queue statuses 132, 134, . . . , 136 from a status array 123 configured in a random access memory 121 accessible to a host system (e.g., 101 having processing cores 151, 153, . . . , 155) that provides storage access commands in the plurality of submission queues 141, 143, . . . , 145.

Optionally, the plurality of submission queues 141, 143, . . . , 145 are also configured in the same random access memory 121 as the status array 123 (e.g., as in FIG. 2, FIG. 3, and FIG. 6).

In one implementation, the status array 123 can include a plurality of slots (e.g., for queue statuses 132, 134, . . . , 136) corresponding to the plurality of submission queues 141, 143, . . . , 145 respectively; and each respective slot can be configured to store data indicative of a current status (e.g., 132, 134, or 136) of a corresponding submission queue (e.g., 141, 143, or 145) in the plurality of submission queues.

For example, the status (e.g., 132, 134, or 136) of the corresponding submission queue (e.g., 141, 143, or 145) can include a count of commands in the corresponding submission queue. For example, the count can be indicated via a TagID or sequence number of a last command added to the end of the corresponding submission queue (e.g., 141, 143, or 145, in a way as discussed in connection with FIG. 7).

For example, the host system 102 can be configured to write queue status data (e.g., queue statuses 132, 134, . . . , 136) into the slots directly without going through the memory sub-system 101. Thus, the memory sub-system 101 can analyze the queue statuses 132, 134, . . . , 136 at time instances decided by the memory subsystem 101 without reading the submission queues 141, 143, . . . , 145.

In some implementations, the status array 123 can be a status queue configured in a cyclic buffer allocated from the random access memory 121. The cyclic buffer of the status queue can have a plurality of slots of a same predetermined size for storing a queue status (e.g., 132, 134, or 136) and an identification of a submission queue for which the queue status (e.g., 132, 134, or 136) is stored. For example, each respective slot among the slots of the status queue can be sufficient to store data configured to identify: a particular submission queue among the plurality of submission queue; and a status of the particular submission queue.

Optionally, the host system 102 can be configured to provide some or all of the queue statuses (e.g., 132, 134, . . . , 136) via writing to a doorbell register 129 in the memory sub-system 101. For example, after receiving in the memory sub-system 101 a request to write to the doorbell register 129 at a predetermined address (e.g., a predetermined PCIe address), the memory sub-system 101 can optionally copy the content of the doorbell register 129 (e.g., a status in the queue status field 139) to the status array 123. For example, the request to write to the doorbell register 129 can identify: a particular submission queue (e.g., via a queue ID field 137) among the plurality of submission queues 141, 143, . . . , 145; and a status (e.g., via a queue status field 139) of the particular submission queue. For example, the memory sub-system 101 can be configured to update the status array 123 and/or a status queue based on the request to write to the doorbell register 129.

Optionally, the analyzing at block 341 can be in response to the request to write to the doorbell register 129. In other implementations, writing to the doorbell register 129 provides a piece of information that is tracked by the queue manager 113 in the memory sub-system 101 and that is evaluated in the determination of the priorities of the submission queues 141, 143, . . . , 145 in having their commands serviced.

At block 343, the method includes determining, by the memory sub-system 101, priorities of the submission queues 141, 143, . . . , 145 based on the analyzing at block 341.

In general, the queue statuses 132, 134, . . . , 136 can include various information used in the determination of the priorities of the submission queues 141, 143, . . . , 145. Such information can include a count of total pending commands in each submission queue (e.g., 141), a count of new commands added to the submission queue (e.g., 141) since the last check of the queue status (e.g., 132) of the submission queue (e.g., 141), whether the host system 102 has written to the doorbell register 129 to explicitly request execution of commands for the submission queue (e.g., 141), and the time sequence of the host system 102 explicitly requests executions for some submission queues (e.g., as indicated in the order of entries in a status queue).

At block 345, the method includes selecting, by the memory sub-system 101, one or more submission queues (e.g., 141 and/or 143) based the priorities.

At block 347, the method includes retrieving, by the memory sub-system 101 and from the one or more submission queues (e.g., 141 and/or 143), a subset of storage access commands in the plurality of submission queues 141, 143, . . . , 145.

In some implementations, the memory sub-system 101 is configured to process commands in batches. Each batch is selected to include no more than a predetermined number of commands. The memory sub-system 101 is configured to distribute the workload of the predetermined number of commands to the selected one or more submission queues and thus to determine the amount of commands to be retrieved from each of the selected submission queues. When the workload for a batch is limited by the predetermined number of commands, the time period between the identification and execution of two successive batches of commands is no longer than a predetermined time interval.

At block 349, the method includes executing, by the memory sub-system 101, the subset of storage access commands.

After the retrieval of the subset of commands (and optionally, before the completion of the execution of the retrieved subset/batch of commands), the memory sub-system 101 can repeat the operations at blocks 341 to 347 to identify and retrieve a next subset/batch of commands based on current queue statues 132, 134, . . . , 136 in the status array 123, which can have been updated by the host system 102 (e.g., the processor cores 151, 153, . . . , 155) since the last checking and analyzing of the queue statues (e.g., in the status array 123 and/or the status queue).

Using the above discussed techniques, the memory sub-system 101 can prioritize the fetching of batches of commands from some of the submission queues 141, 143, . . . , 145 for execution based on an analysis of current queue statuses 132, 134, . . . , 136 without reading the submission queues 141, 143, . . . , 145. Thus, the memory sub-system 101 can support a varying count of the plurality of submission queues 141, 143, . . . , 145, which can be significantly smaller than 2048, or significantly larger than 2048, for a variety of applications (e.g., AI applications, non-AI applications).

A non-transitory computer storage medium can be used to store instructions programmed to implement the queue managers 113 in the host system 102 and the memory sub-system 101. When the instructions are executed by the processing device 118, the controller 115, and the processing device 117, the instructions cause the host system 102 and/or the memory sub-system 101 to perform the methods discussed above.

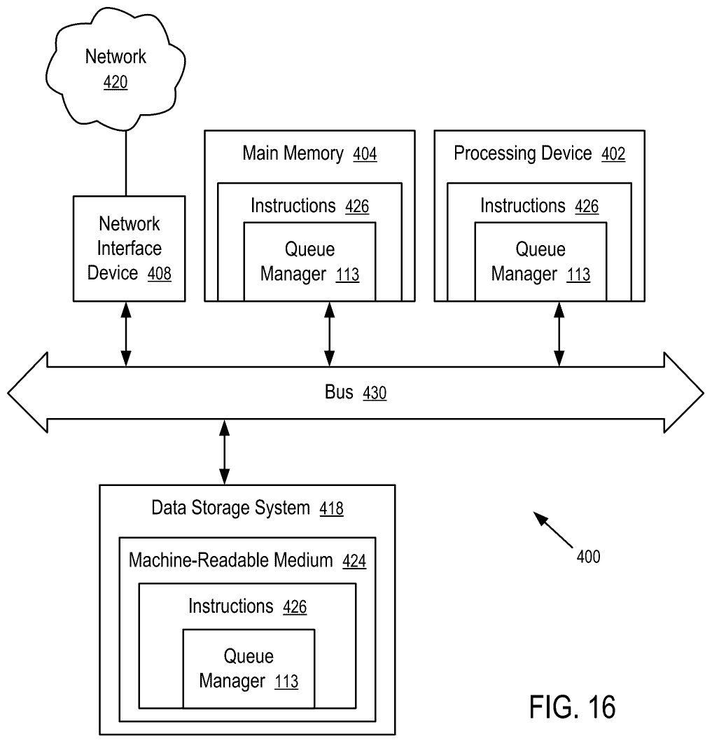

FIG. 16 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of queue managers 113 (e.g., to execute instructions to perform operations corresponding to the queue managers 113 described with reference to FIGS. 1-15). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the queue managers 113 described with reference to FIGS. 1-15. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method, comprising:
analyzing, by a memory sub-system, queue statuses of a plurality of submission queues without accessing the submission queues;
determining, by the memory sub-system, priorities of the submission queues based on the analyzing;
selecting, by the memory sub-system, one or more submission queues based the priorities;
retrieving, by the memory sub-system and from the one or more submission queues, a subset of storage access commands in the plurality of submission queues; and
executing, by the memory sub-system, the subset of storage access commands.

2. The method of claim 1, further comprising:
retrieving, by the memory sub-system, the queue statuses from a status array configured in a random access memory accessible to a host system that provides storage access commands in the plurality of submission queues.

3. The method of claim 2, wherein the plurality of submission queues are also configured in the random access memory.

4. The method of claim 3, wherein the status array includes a plurality of slots corresponding to the plurality of submission queues respectively; and each respective slot among the slots is configured to store data indicative of a status of a corresponding submission queue among the plurality of submission queues.

5. The method of claim 4, wherein the status of the corresponding submission queue includes a count of commands in the corresponding submission queue.

6. The method of claim 5, wherein the host system is configured to write queue status data to the slots directly without going through the memory sub-system.

7. The method of claim 3, wherein the status array is configured in a cyclic buffer allocated from the random access memory and has a plurality of slots; and each respective slot among the slots is sufficient to store data configured to identify:
a particular submission queue among the plurality of submission queues; and
a status of the particular submission queue.

8. The method of claim 2, further comprising:
receiving, by the memory sub-system, a request to write to a register at a predetermined address, wherein the request is configured to identify:
a particular submission queue among the plurality of submission queues; and
a status of the particular submission queue; and
updating, by the memory sub-system, the status array based on the request.

9. The method of claim 8, wherein the analyzing is in response to the request; and
a count of the plurality of submission queues is larger than 2048.

10. A memory sub-system, comprising:
non-volatile memory cells configured to provide a storage capacity of the memory sub-system; and
at least one processor configured via instructions to:
perform an analysis of queue statuses of a plurality of submission queues without accessing the submission queues;
determine priorities of the submission queues based on a result of the analysis;
select one or more submission queues based the priorities;
retrieve, from the one or more submission queues, a subset of storage access commands in the plurality of submission queues; and
execute the subset of storage access commands.

11. The memory sub-system of claim 10, wherein the at least one processor is further configured to:
retrieve the queue statuses from a status array configured in a random access memory accessible to a host system that provides storage access commands in the plurality of submission queues.

12. The memory sub-system of claim 11, wherein the plurality of submission queues are also configured in the random access memory.

13. The memory sub-system of claim 12, wherein the status array is configured in a cyclic buffer allocated from the random access memory and has a plurality of slots; and each respective slot among the slots is configured to store data configured to identify:
a particular submission queue among the plurality of submission queues; and
a status of the particular submission queue.

14. The memory sub-system of claim 11, wherein the status array includes a plurality of slots corresponding to the plurality of submission queues respectively; and each respective slot among the slots is configured to store data indicative of a status of a corresponding submission queue among the plurality of submission queues.

15. The memory sub-system of claim 14, wherein the status of the corresponding submission queue includes a count of commands in the corresponding submission queue.

16. The memory sub-system of claim 15, wherein the slots are configured to allow the host system to write queue status data to the slots directly without going through the memory sub-system.

17. The memory sub-system of claim 11, wherein the at least one processor is further configured to:
receive a request to write to a register at a predetermined address, wherein the request is configured to identify:
a particular submission queue among the plurality of submission queues; and
a status of the particular submission queue; and
update the status array based on the request.

18. A non-transitory computer storage medium storing instructions which, when executed in a memory sub-system, cause the memory sub-system to perform a method, comprising:
analyzing, by the memory sub-system, queue statuses of a plurality of submission queues without accessing the submission queues;
determining, by the memory sub-system, priorities of the submission queues based on the analyzing;
selecting, by the memory sub-system, one or more submission queues based the priorities;
retrieving, by the memory sub-system and from the one or more submission queues, a subset of storage access commands in the plurality of submission queues; and
executing, by the memory sub-system, the subset of storage access commands.

19. The non-transitory computer storage medium of claim 18, wherein the priorities are first priorities; the one or more submission queues are one or more first submission queues; and the subset of storage access commands is a first subset of storage access commands; and the method further comprises, after the retrieving of the subset of storage access commands:
performing, by the memory sub-system, an analysis of current queue statuses of the plurality of submission queues without accessing the plurality of submission queues;
determining, by the memory sub-system, second priorities of the plurality of submission queues based on a result of the analysis of the current queue statues;
selecting, by the memory sub-system, one or more second submission queues based the second priorities;
retrieving, by the memory sub-system and from the one or more second submission queues, a second subset of storage access commands in the plurality of submission queues; and
executing, by the memory sub-system, the second subset of storage access commands after execution of the first subset of storage access commands.

20. The non-transitory computer storage medium of claim 18, wherein the method further comprises:
retrieving, by the memory sub-system, the queue statuses from a status array configured in a random access memory accessible to a host system that provides storage access commands in the plurality of submission queues;
wherein the plurality of submission queues are also configured in the random access memory.
